(19) United States
(12) Patent Application Publication
(10) Pub. No.: US 2012/0162268 A1
(43) Pub. Date: Jun. 28, 2012

(54) Transparent Display Active Panels

(75) Inventors: Rod G. Fleck, Bellevue, WA (US); Derek Leslie Knee, Fort Collins, CO (US); David D. Bohn, Fort Collins, CO (US); Paul M. O'Brien, Sammamish, WA (US)

(73) Assignee: Microsoft Corporation, Redmond, WA (US)

(21) Appl. No.: 12/977,943

(22) Filed: Dec. 23, 2010

(51) Int. Cl. G09G 3/36; G09G 5/10; G02F 1/01

(52) U.S. Cl. 345/690; 359/238; 345/102

(57) ABSTRACT

In embodiments of transparent display active panels, a display device includes a lighting system that directs light from a light source to illuminate a display panel. A multi-mode panel is operable as a transparent panel of the display device, and is further operable for activation to absorb or reflect a portion of the light from the light source. An active diffuser is operable as an additional transparent panel of the display device, and is further operable for activation to diffuse the light that illuminates the display panel. The display device also includes a display controller that controls the activation of the multi-mode panel and the active diffuser.

### BACKGROUND

Mobile phones and portable devices that display information when open or closed are typically implemented with two displays. For example, a mobile phone may have a larger, primary display for use when the device is open, and a smaller, secondary display on the back of the device to display the current time or a notification of an incoming call. The current flip, slide, or swivel type of phone devices allow a user to interact with all of the device functions when the primary display is open. However, many of the device functions may be limited or disabled when the primary display is closed over the device and/or when a smaller, secondary display is in use. Additionally, users typically want the smallest possible device to conveniently carry in a pocket or purse, but also want larger user interface surfaces for a primary display, keypad, and potentially a secondary display. Some tablet notebook computers and/or phones that have a single display may be used when in an open or closed position, but need relatively complex rotating hinges and hardware components to position the display screen for use while open or closed.

### SUMMARY

This summary is provided to introduce simplified concepts of transparent display active panels that are further described below in the Detailed Description. This summary is not intended to identify essential features of the claimed subject matter, nor is it intended for use in determining the scope of the claimed subject matter.

Transparent display active panels are described. In embodiments, a display device includes a lighting system that directs light from a light source to illuminate a display panel. A multi-mode panel is operable as a transparent panel of the display device, and is further operable for activation to absorb or reflect a portion of the light from the light source. An active diffuser is operable as an additional transparent panel of the display device, and is further operable for activation to diffuse the light that illuminates the display panel. The display device also includes a display controller that controls the activation of the multi-mode panel and the active diffuser.

In other embodiments, the multi-mode panel is implemented as an active shutter operable for activation to absorb the portion of the light from the light source that is reflected away from the display panel. Alternatively, the multi-mode panel is implemented as an active reflector operable for activation to reflect the portion of the light from the light source back to the display panel. The multi-mode panel and the active diffuser can be switched-off for transparency to permit an image being viewable through the display device and to allow ambient light being directed to illuminate the display panel of the display device.

In other embodiments, the multi-mode panel is operable for activation of a first zone for direct display on the display panel of the display device, and is further operable for concurrent transparent display of a second zone of the multi-mode panel. The display controller can be implemented to control the activation of the multi-mode panel for transparency based on all of the multi-mode panel, a section or zone of the multi-mode panel, a pixel of the multi-mode panel, or a set of pixels of the multi-mode panel.

### BRIEF DESCRIPTION OF THE DRAWINGS

Embodiments of transparent display active panels are described with reference to the following drawings. The same numbers are used throughout the drawings to reference like features and components:

FIG. 1 illustrates examples of a portable device and various embodiments of transparent display active panels.

FIG. 2 illustrates an example transparent display assembly in accordance with one or more embodiments.

FIG. 3 illustrates an example of transparent display active panels in accordance with one or more embodiments.

FIG. 4 illustrates another example of transparent display active panels in accordance with one or more embodiments.

FIG. 5 illustrates example method(s) of transparent display active panels in accordance with one or more embodiments.

FIG. 6 illustrates various components of an example device that can implement embodiments of transparent display active panels.

### DETAILED DESCRIPTION

Embodiments of transparent display active panels are described. A portable device, such as a mobile phone or computer device, includes a display device that can be controlled for transparent and non-transparent display. The display device includes various display panels and surfaces that are assembled between front and back display surfaces of the display device, and different combinations of the display panels and surfaces may be utilized to implement a transparent display. The transparent display active panels include an active reflector, an active shutter, and/or an active diffuser that are each electrically switchable and/or independently software controlled for transparency or activation.

An active diffuser is operable to scatter and/or diffuse the light that illuminates a display panel of the display device, and may be utilized in low-light and for a low power mode to scatter light from the environment to illuminate the display panel. An active shutter is operable to absorb a portion of the light from the light source that is reflected away from the display panel, and may be utilized to prevent an image from being viewable through the back of a transparent display device. An active reflector is operable to reflect the portion of the light from the light source back to the display panel, and may be utilized for improved display illumination and also to prevent an image from being viewable through the back of a transparent display device.

While features and concepts of the described systems and methods for transparent display active panels can be implemented in any number of different environments, systems, devices, and/or various configurations, embodiments of transparent display active panels are described in the context of the following example devices, systems, and configurations.

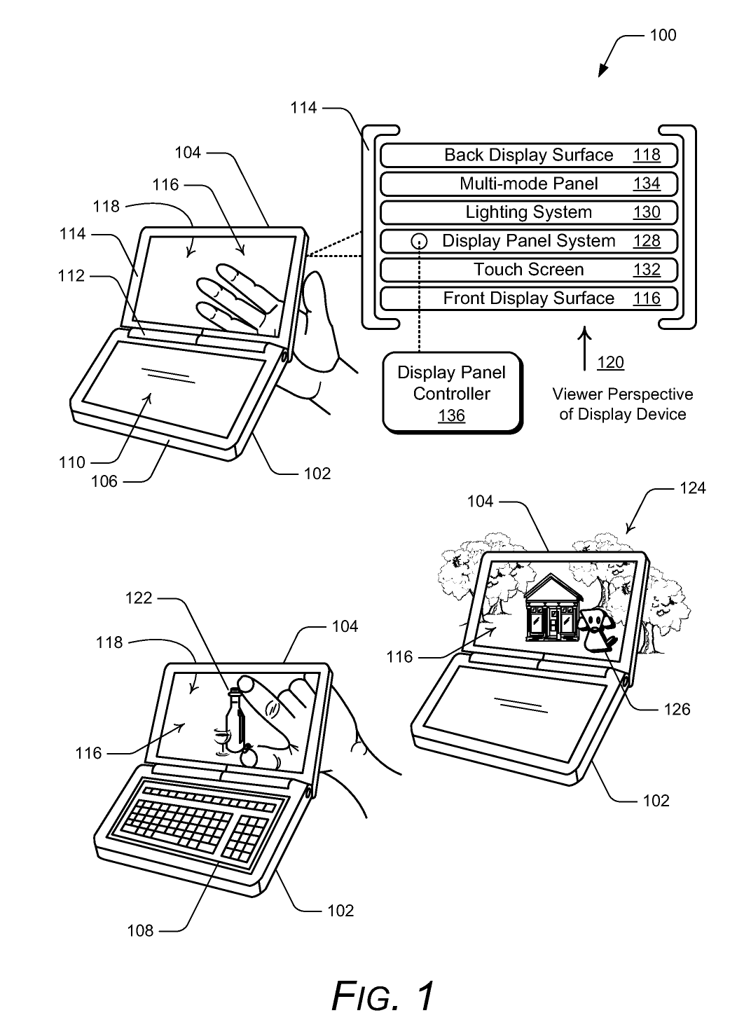

FIG. 1 illustrates examples 100 of a portable device 102 and various embodiments of transparent display active panels. The portable device includes a display device 104 and a handheld base 106 that may include a physical keyboard (shown at 108) or an additional display device 110 as an integrated component of the portable device. The additional display device may be utilized to display text, graphics, images, user interfaces, and/or a virtual keyboard, such as when an implementation of a portable device does not include a physical keyboard. In the examples, the display device 104 is movably coupled at 112 to the handheld base of the portable device, such as with a rotating hinge, slide track, flip mechanism, or other coupling device. The display device can open and close over the handheld base, such as when folded, slid, or flipped closed over the additional display device, folded around to the back of the handheld base, or any position in-between approximately zero degrees (0°) and three-hundred sixty degrees (360°) relative to the handheld base.

The display device 104 includes a display housing 114 that supports various display panels and surfaces that may be utilized to assemble the display device. In this example, the display device includes a front display surface 116, and includes a back display surface 118. The front display surface and the back display surface are viewable from opposite sides of the display device. A user of the portable device 102 may generally view the display device 104 through the front display surface 116, shown for reference as a viewer perspective of the display device at 120.

A displayed image 122 may be viewable through the front and back display surfaces, and as illustrated, the display device 104 is transparent. As described herein, the transparency of a display device may be a percentage of transparency as measured with light detection equipment and/or as visually determined or perceived by a user when viewing an environment as seen through the various display panels and surfaces of the display device.

In the illustrated examples, a hand may be viewable through the front and back display surfaces of the display device, such as when viewed through the front of the display device. An environment 124 behind the display device can also be viewable through the front and back display surfaces of the display device, and a displayed image may appear projected into the environment for an augmented view of reality. For example, a displayed image 126 of the dog may appear projected into the environment 124 that includes trees and a building behind the display device and viewable through the front and back display surfaces of the display device.

In addition to the front display surface 116 and the back display surface 118, the display device 104 includes a display panel system 128 that is located between the front and back display surfaces. The display panel system is implemented to display images that are then viewable through the front and/or back display surfaces of the display device. The display device includes a lighting system 130 that illuminates the display panel for image display. The lighting system can include a light source, a light guide that directs light generated by the light source, and/or a diffuser that scatters and diffuses the light to uniformly illuminate the display panel. The lighting system may also be referred to as a backlight unit.

The display device may also include a touch screen 132 that is located between the front and back display surfaces to sense a touch input to either of the front display surface or the back display surface. Alternatively, the display device may include a first touch screen located proximate the front display surface and a second touch screen located proximate the back display surface, and the touch screens sense touch inputs to the respective front and back display surfaces.

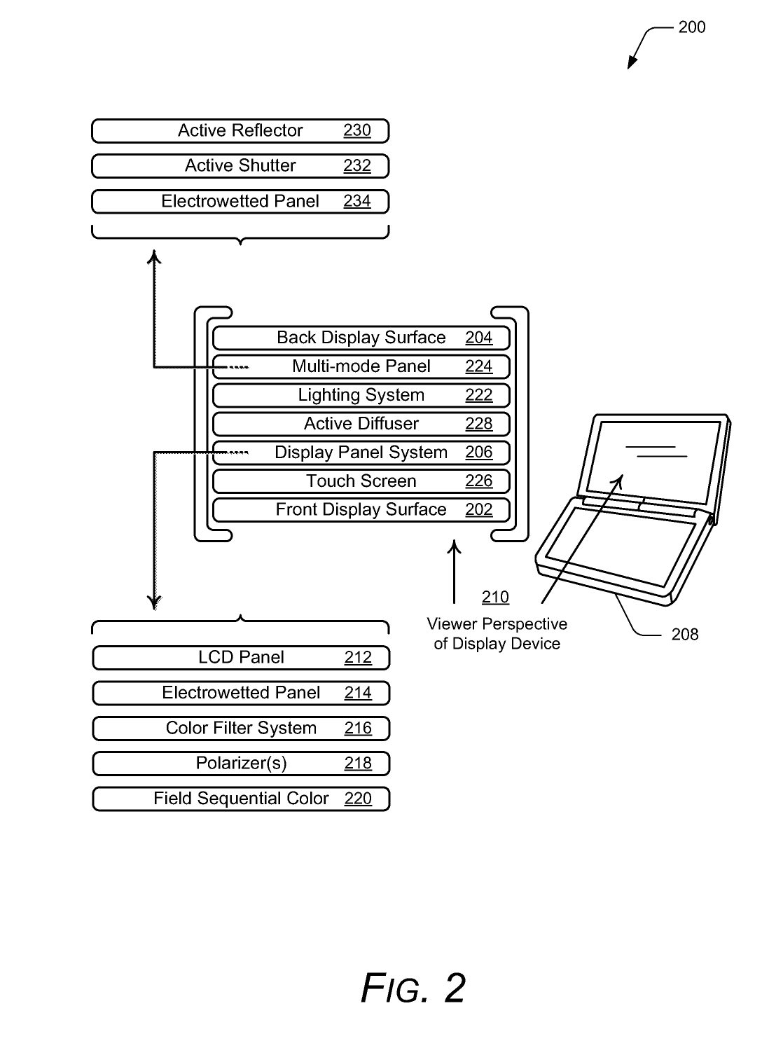

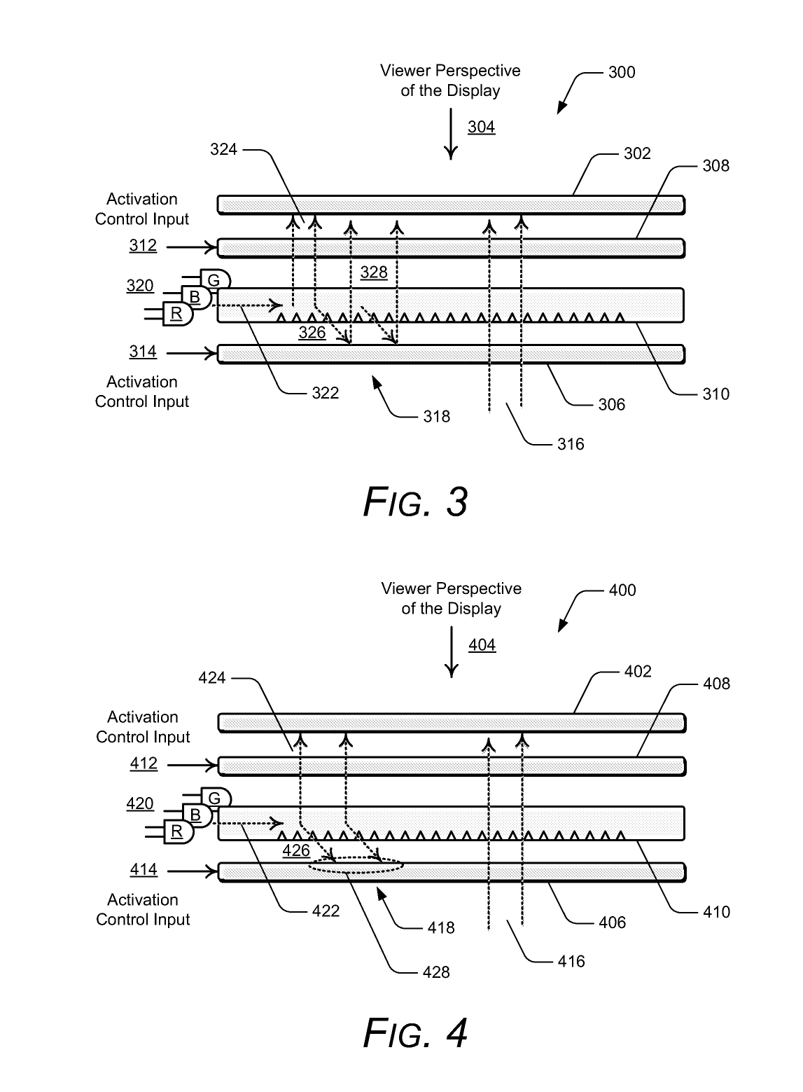

The display device 104 includes a multi-mode panel 134 located between the front display surface 116 and the back display surface 118. In embodiments, the multi-mode panel is operable to switch on and off, such as to prevent an image from being viewable through the front display surface or the back display surface, or for transparency to permit the image being viewable through the front and back display surfaces. The multi-mode panel may be implemented to switch on and/or off the entire panel, sections of the panel, and/or individual pixels of the panel, such as when implemented with an active matrix in an active shutter. In embodiments of transparent display active panels, the multi-mode panel can be implemented as an active reflector, as further described with reference to FIG. 2. Alternatively, the multi-mode panel can be implemented as an active shutter, as further described with reference to FIG. 3. In a closed mode of the portable device 102, such as when the display device 104 is closed over the base of the device, an active reflector can be used in a reflective mode with an inactive backlight unit, and ambient or environment light reflected off of the active reflector illuminates the display panel.

In the FIG. 1 examples, the display device 104 includes a display controller 136 that is implemented to control display modes of the display device for transparent and non-transparent display. The display controller can be implemented as computer-executable instructions, such as a software component, and executed by one or more processors to implement various embodiments for a transparent display. In practice, the portable device 102 is implemented with a processor (e.g., a CPU), a graphics processor (e.g., a GPU), and an internal display controller to drive display content to the display device. In the display device 104, the display panel system 128 may include the display controller 136 that drives each pixel according to the type of display at various voltages.

In various configurations, such as when the display device 104 is positioned open relative to the handheld base 106 of the portable device (e.g., as illustrated in the examples), the display controller 136 can activate the display device to prevent a displayed image from being viewable through the front display surface 116 or the back display surface 118. Alternatively, the display controller can activate the display device for transparency to permit the displayed image being viewable through the front and back display surfaces. Similarly, the display controller can activate the display device for a transparent view of the environment 124, which is viewable through the display device. For example, the display controller can control and switch-on the multi-mode panel 134 of the display device to prevent a displayed image from being viewable through the back display surface, or switch-off the multi-mode panel for transparency to permit the displayed image being viewable through the back display surface.

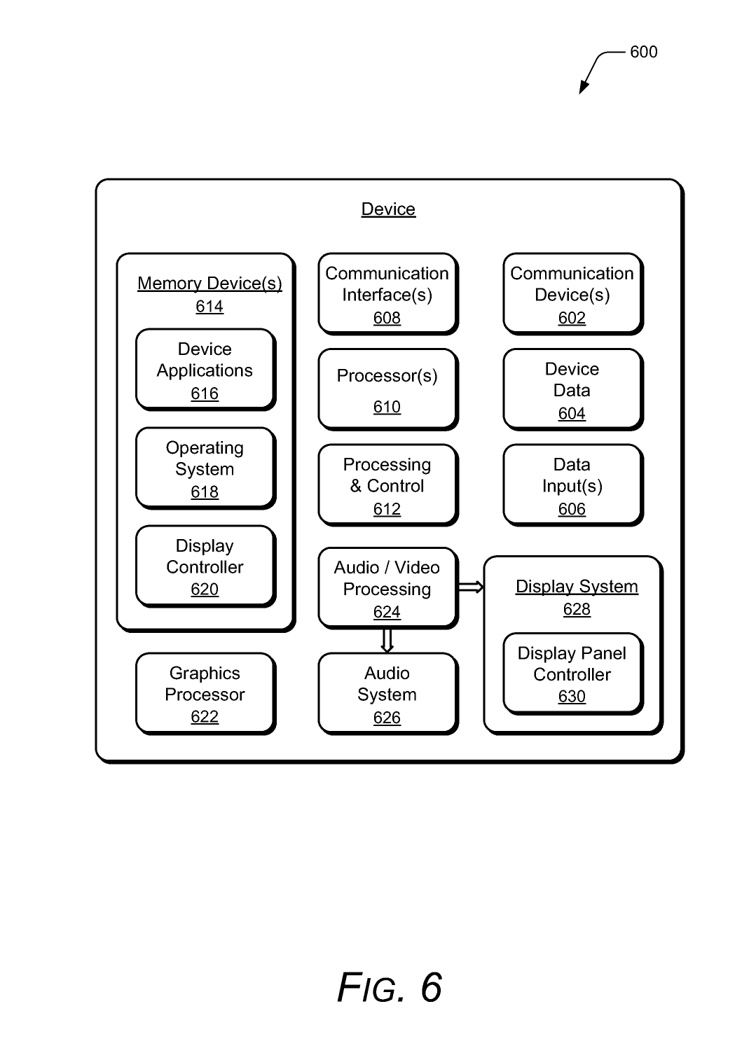

The portable device 102 may be configured as any type of client or user device that includes wired and/or wireless devices, and may be implemented as a consumer, computer (e.g., a laptop or tablet device), portable, communication, phone (e.g., a dual-display phone), appliance, gaming, media playback, and/or electronic device. The portable device can be implemented with one or more processors, data communication components, memory components, navigation components, data processing and control circuits, and a display system. Further, any of the portable devices described herein can be implemented with any number and combination of differing components as further described with reference to the example device shown in FIG. 6.

FIG. 2 illustrates an example transparent display assembly 200 that includes various display panels and surfaces as described above with reference to FIG. 1. Embodiments of transparent display active panels are implemented to maximize light efficiency and transparency. The transparency of a display device may be diminished, primarily due to polarizers (e.g., in an LCD implementation), color filters, and the light efficiency of a light source used to illuminate a display panel. As described above, the transparency of a transparent display may be a percentage of transparency as measured and/or as visually determined or perceived by a user when viewing through the transparent display assembly.

The transparent display assembly 200 includes a front display surface 202 and a back display surface 204. The front display surface and the back display surface are viewable from opposite sides of the transparent display assembly. In addition to the front and back display surfaces, the transparent display assembly includes a display panel system 206 that is located between the front and back display surfaces. The display panel system displays images that are viewable through the front and/or back display surfaces of the transparent display assembly. A user of a device 208 that includes the transparent display assembly may generally view the display through the front display surface 202, shown for reference as a viewer perspective of the display at 210. It is also possible that some implementations can only be viewed from one side.

In various embodiments, the display panel system 206 may include any one or combination of an LCD panel 212, an electrowetted panel 214, a color filter system 216 that may be implemented as a passive or active system, one or more polarizers 218 that may be implemented as passive or active, and/or an implementation of field sequential color 220. The LCD panel 212 can be implemented as a transparent LCD panel. An LCD implementation includes polarizers, and may include an implementation of field sequential color rather than using color filters. The color filter system 216 can be implemented for a percentage of transparency that permits an image being viewable through the display device. Similarly, the polarizers 218 can be implemented for a percentage of transparency that permits the image being viewable through the display device. In embodiments, an implementation of field sequential color 220 may be utilized in place of the color filters.

The transparent display assembly 200 also includes a lighting system 222 that illuminates the display panel for image display. In this example, a light source of the lighting system is located or positioned between the display panel system 206 and a multi-mode panel 224. Alternatively, the light source can be implemented as a front-light that is located or positioned between the display panel system and a touch screen 226. In this example, the transparent display assembly also includes an active diffuser 228 that scatters and/or diffuses the light to uniformly illuminate the display panel. In an alternate implementation, the lighting system can be replaced with a transparent OLED solution. In this case, the active reflector is used to recycle light from the back to the front display 206 (and an active diffuser may or may not be utilized due to the diffuse nature of OLED light). Alternatively, the lighting system may be eliminated and simply use ambient light from the back side which is then blocked (creating black) by the LCD panel. In addition to the touch-screen 226, the display device may include a second touch screen located proximate the back display surface, and the touch screens sense touch inputs to the respective front and back display surfaces.

The multi-mode panel 224 of the transparent display assembly 200 is located between the front display surface 202 and the back display surface 204. The multi-mode panel may be implemented to switch on and/or off the entire panel, sections of the panel, and/or individual pixels of the panel. In various embodiments, the multi-mode panel may include any one or combination of an active reflector 230, an active shutter 232, and/or an implementation of an electrowetted panel 234 (e.g., implemented as an active reflector). In various implementations, the active reflector may be utilized for efficiency, although not required. The active reflector and/or active shutter can be implemented to permit or prevent one side of a display from being viewable, such as through the back display surface.

The active reflector 230 and the active shutter 232 are operable to switch-on and prevent an image from being viewable through the front display surface 202 or the back display surface 204, and further operable to switch-off for transparency to permit the image being viewable through the front and back display surfaces. The active reflector 230 can be implemented as a dual-state mirror having a transparent state for transparency, and a reflective state to reflect and recycle light that is lost, such as from an illuminated light guide to illuminate the display. The active shutter 232 can be implemented as an LCD shutter that provides for variable light transmissivity based on an applied voltage. In embodiments, an electrowetting implementation of the electrowetted panel 234 does not include polarizers, and may or may not include color filters. The active diffuser 228 and any of the described multi-mode panel solutions, such as an active reflector, active shutter, or electrowetted panel, can be implemented to operate on the whole panel, sections of the panel, and/or on a pixel-by-pixel basis.

Electrochromatic type materials can be utilized to implement electrically switchable, active panels, such as an active reflector and active diffuser that can be switched-off for transparency. For example, an active reflector may be implemented with a CH-LCD Aluminum-Hydride material. Alternatively or in addition, other electrically switchable materials that have a high transmissivity in an open state and a high reflectance in a closed state may be utilized to implement transparent display active panels. Materials that have bi-stable properties have no active power component and may also be utilized, particularly for low power modes of a mobile device that includes an integrated transparent display.

FIG. 3 illustrates an example of display components 300 in embodiments of transparent display active panels, which may be implemented as components of the transparent display assembly 200 described with reference to FIG. 2. The display components include a display panel 302, such as described with reference to the display panel system shown in FIG. 2. An orientation reference at 304 indicates a viewer perspective of the display panel, such as when a user of a device that includes the display components views the display panel. The display components include an active reflector 306 and an active diffuser 308 that are implemented as transparent display active panels. The display components also include a light guide 310 that directs light to illuminate the display panel. In an alternate implementation, an additional active reflector can be utilized to position the light guide 310 between two active reflectors.

The active diffuser 308 can be operable as a transparent panel, or activated to uniformly scatter and/or diffuse the light that illuminates the display panel when an activation control input 312 is initiated from the display controller to switch-on the active diffuser. Similarly, the active reflector 306 can be operable as a transparent panel, or activated as a reflector to reflect light when an activation control input 314 is initiated from the display controller to switch-on and close the active reflector. When operable as a transparent panel, the active reflector is switched-off which allows ambient light 316 through to illuminate the display panel 302, such as when a device is used in a low power mode and the active diffuser scatters the light from the environment to illuminate the display panel.

When switched-on and operable as a reflector at 318, a portion of the light that is generated from a light source is reflected by the active reflector 306 to illuminate the display panel. For example, a light source 320 is implemented as an edge-lighted source that generates light 322, which is directed by light extraction features within the light guide 310 to illuminate the display panel with directed light 324. A portion of the light 322 that is generated by the light source is also lost light 326 that is reflected by the active reflector as reflected light 328 to further illuminate the display panel. In implementations, the light source 320 can be a white light, or separate colors as illustrated, which may be utilized for color imaging using field sequential color averaging.

In embodiments, the active reflector 306 can be implemented for display zones, such as for activation of a first zone for direct display on the display panel of the display device, and then a second zone operable for concurrent transparent display. For example, a first zone of the active reflector (e.g., the left half of the active panel as illustrated) can be switched-on at 318 to reflect the lost light 326 as the reflected light 328 to illuminate a first section of the display panel 302 for direct display, and to prevent a displayed image from being viewable through a display device. A second zone of the active reflector (e.g., the right half of the active panel as illustrated) can be switched-off for transparency which allows the ambient light 316 through to illuminate the display panel 302. In embodiments, the active reflector can be activation controlled for transparency based on all of the active panel, a section or zone of the active panel, a pixel of the active panel, or a set of pixels of the active panel.

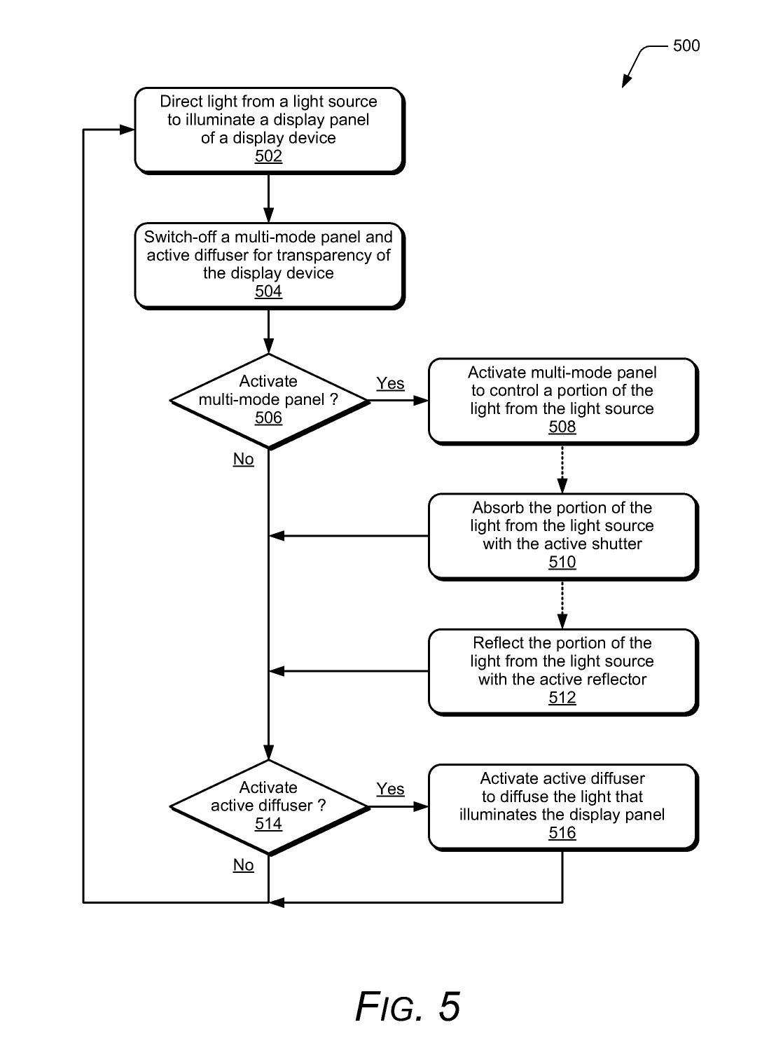

FIG. 4 illustrates an example of display components 400 in embodiments of transparent display active panels, which may be implemented as components of the transparent display assembly 200 described with reference to FIG. 2. The display components include a display panel 402, such as described with reference to the display panel system shown in FIG. 2. An orientation reference at 404 indicates a viewer perspective of the display panel, such as when a user of a device that includes the display components views the display panel. The display components include an active shutter 406 and an active diffuser 408 that are implemented as transparent display active panels. The display components also include a light guide 410 that directs light to illuminate the display panel.

The active diffuser 408 can be operable as a transparent panel, or activated to uniformly scatter and/or diffuse the light that illuminates the display panel when an activation control input 412 is initiated from the display controller to switch-on the active diffuser. Similarly, the active shutter 406 can be operable as a transparent panel, or activated to absorb light when an activation control input 414 is initiated from the display controller to switch-on and close the active shutter. When operable as a transparent panel, the active shutter is switched-off which allows ambient light 416 through to illuminate the display panel 402, such as when a device is used in a low power mode and the active diffuser scatters the light from the environment to illuminate the display panel.

When switched-on and operable as a shutter at 418, a portion of the light that is generated from a light source is absorbed by the active shutter 406. For example, a light source 420 is implemented as an edge-lighted source that generates light 422, which is directed by light extraction features within the light guide 410 to illuminate the display panel with directed light 424. A portion of the light 422 that is generated by the light source is also lost light 426 that is absorbed at 428 by the active shutter. In implementations, the light source 420 can be a white light, or separate colors as illustrated, which may be utilized for color imaging using field sequential color averaging.

In embodiments, the active shutter 406 can be implemented for display zones, such as for activation of a first zone for direct display on the display panel of the display device, and then a second zone operable for concurrent transparent display. For example, a first zone of the active shutter (e.g., the left half of the active panel as illustrated) can be switched-on at 418 to absorb the lost light 426 for direct display, and to prevent a displayed image from being viewable through a display device. A second zone of the active shutter (e.g., the right half of the active panel as illustrated) can be switched-off for transparency which allows the ambient light 416 through to illuminate the display panel 402. In embodiments, the active shutter can be activation controlled for transparency based on all of the active panel, a section or zone of the active panel, a pixel of the active panel, or a set of pixels of the active panel.

Example method 500 is described with reference to FIG. 5 in accordance with one or more embodiments of transparent display active panels. Generally, any of the functions, methods, procedures, components, and modules described herein can be implemented using software, firmware, hardware (e.g., fixed logic circuitry), manual processing, or any combination thereof. A software implementation represents program code that performs specified tasks when executed by a computer processor. The example methods may be described in the general context of computer-executable instructions, which can include software, applications, routines, programs, objects, components, data structures, procedures, modules, functions, and the like. The program code can be stored in one or more computer-readable memory devices, both local and/or remote to a computer processor. The methods may also be practiced in a distributed computing environment by multiple computer devices. Further, the features described herein are platform-independent and can be implemented on a variety of computing platforms having a variety of processors.

FIG. 5 illustrates example method(s) 500 of transparent display active panels. The order in which the method blocks are described are not intended to be construed as a limitation, and any number of the described method blocks can be combined in any order to implement a method, or an alternate method.

At block 502, light is directed from a light source to illuminate a display panel of a display device. For example, the light guide 310 (FIG. 3) directs the light 322 that is generated by the light source 320 to illuminate the display panel 302. Alternatively or in addition, the ambient light 316 is directed through the light guide to illuminate the display panel. Similarly, the light guide 410 (FIG. 4) directs the light 422 that is generated by the light source 420 to illuminate the display panel 402. Alternatively or in addition, the ambient light 416 is directed through the light guide to illuminate the display panel.

At block 504, a multi-mode panel and active diffuser are switched-off for transparency to permit an image being viewable through the display device. For example, the display controller controls activation of the active reflector 306 and/or the active diffuser 308, and switches the active panels off for transparency of a display device. Similarly, the display controller controls activation of the active shutter 406 and/or the active diffuser 408, and switches the active panels off for transparency of a display device.

At block 506, a determination is made as to whether to activate the multi-mode panel. If the multi-mode panel is activated (i.e., “yes” from block 506), then at block 508, the multi-mode panel is activated to control the portion of the light from the light source. When the multi-mode panel is implemented as an active shutter, then optionally at block 510, the portion of the light from the light source is absorbed with the active shutter. For example, the display controller controls activation of the active shutter 406 and switches the active panel on with an activation control input 414. When switched-on, the active shutter absorbs a portion of the light that is generated from the light source 420, and is operable to prevent an image from being viewable through the back of a transparent display device.

When the multi-mode panel is implemented as an active reflector, then optionally at block 512, the portion of the light from the light source is reflected with the active reflector. For example, the display controller controls activation of the active reflector 306 and switches the active panel on with an activation control input 314. When switched-on, the active reflector reflects a portion of the light that is generated from the light source 320 to illuminate the display panel 302, and is operable to prevent an image from being viewable through the back of a transparent display device.

If the multi-mode panel is not activated (i.e., “no” from block 506), or continuing from either of optional blocks 510 and 512, then at block 514, a determination is made as to whether to activate the active diffuser. If the active diffuser is activated (i.e., “yes” from block 514), then at block 516, the active diffuser is activated to diffuse the light that illuminates the display panel. For example, the display controller controls activation of the active diffuser 308 and switches the active panel on with an activation control input 312 to scatter and/or diffuse the light that illuminates the display panel 302. Similarly, the display controller controls activation of the active diffuser 408 and switches the active panel on with an activation control input 412 to scatter and/or diffuse the light that illuminates the display panel 402. If the active diffuser is not activated (i.e., “no” from block 514), or continuing from block 516, then the method continues at block 502 to direct the light that is generated from the light source to illuminate a display panel of the display device.

FIG. 6 illustrates various components of an example device 600 that can be implemented as a portable device as described with reference to any of the previous FIGS. 1-5. In embodiments, the device may be implemented as any one or combination of a fixed or mobile device, in any form of a consumer, computer, portable, user, communication, phone, navigation, television, appliance, gaming, media playback, and/or electronic device. The device may also be associated with a user (i.e., a person) and/or an entity that operates the device such that a device describes logical devices that include users, software, firmware, hardware, and/or a combination of devices.

The device 600 includes communication devices 602 that enable wired and/or wireless communication of device data 604, such as received data, data that is being received, data scheduled for transmission, data packets of the data, etc. The device data or other device content can include configuration settings of the device, media content stored on the device, and/or information associated with a user of the device. Media content stored on the device can include any type of audio, video, and/or image data. The device includes one or more data inputs 606 via which any type of data, media content, and/or inputs can be received, such as user-selectable inputs, messages, communications, music, television content, recorded video content, and any other type of audio, video, and/or image data received from any content and/or data source.

The device 600 also includes communication interfaces 608, such as any one or more of a serial, parallel, network, or wireless interface. The communication interfaces provide a connection and/or communication links between the device and a communication network by which other electronic, computing, and communication devices communicate data with the device.

The device 600 includes one or more processors 610 (e.g., any of microprocessors, controllers, and the like) which process various computer-executable instructions to control the operation of the device. Alternatively or in addition, the device can be implemented with any one or combination of software, hardware, firmware, or fixed logic circuitry that is implemented in connection with processing and control circuits which are generally identified at 612. Although not shown, the device can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

The device 600 also includes one or more memory devices 614 (e.g., computer-readable storage media) that enable data storage, such as random access memory (RAM), non-volatile memory (e.g., read-only memory (ROM), flash memory, etc.), and a disk storage device. A disk storage device may be implemented as any type of magnetic or optical storage device, such as a hard disk drive, a recordable and/or rewriteable disc, and the like.

Computer readable media can be any available medium or media that is accessed by a computing device. By way of example, and not limitation, computer readable media may comprise storage media and communication media. Storage media include volatile and non-volatile, removable and non-removable media implemented in any method or technology for storage of information, such as computer-readable instructions, data structures, program modules, or other data. Storage media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by a computer.

Communication media typically embody computer-readable instructions, data structures, program modules, or other data in a modulated data signal, such as carrier wave or other transport mechanism. Communication media also include any information delivery media. The term modulated data signal means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

A memory device 614 provides data storage mechanisms to store the device data 604, other types of information and/or data, and various device applications 616. For example, an operating system 618 and a display controller 620 can be maintained as software applications with a memory device and executed on the processors. The device applications may also include a device manager, such as any form of a control application, software application, signal processing and control module, code that is native to a particular device, a hardware abstraction layer for a particular device, and so on.

The device 600 may also include a graphics processor 622, and includes an audio and/or video processing system 624 that generates audio data for an audio system 626 and/or generates display data for a display system 628. The audio system and/or the display system may include any devices that process, display, and/or otherwise render audio, video, display, and/or image data. For example, the display system includes a display panel controller 630. Display data and audio signals can be communicated to an audio device and/or to a display device via an RF (radio frequency) link, S-video link, composite video link, component video link, DVI (digital video interface), analog audio connection, or other similar communication link. In implementations, the audio system and/or the display system are external components to the device. Alternatively, the audio system and/or the display system are integrated components of the example device.

Although embodiments of transparent display active panels have been described in language specific to features and/or methods, the subject of the appended claims is not necessarily limited to the specific features or methods described. Rather, the specific features and methods are disclosed as example implementations of transparent display active panels.

1. A display device, comprising:
a lighting system configured to direct light from a light source to illuminate a display panel;
a multi-mode panel operable as a transparent panel and further operable for activation to at least one of absorb or reflect a portion of the light from the light source; and
a memory and a processor to implement a display controller configured to control the activation of the multi-mode panel.

2. A display device as recited in claim 1, wherein the multi-mode panel comprises an active shutter operable for activation control by the display controller to absorb the portion of the light from the light source that is reflected away from the display panel.

3. A display device as recited in claim 1, wherein the multi-mode panel comprises an active reflector operable for activation control by the display controller to reflect the portion of the light from the light source back to the display panel.

4. A display device as recited in claim 1, wherein the light is ambient light directed to illuminate the display panel, the ambient light received through the multi-mode panel when operable as the transparent panel.

5. A display device as recited in claim 1, further comprising an active diffuser operable as an additional transparent panel and further operable for activation to diffuse the light that illuminates the display panel.

6. A display device as recited in claim 5, wherein the display controller is further configured to control the activation of the active diffuser.

7. A display device as recited in claim 5, wherein the multi-mode panel and the active diffuser are configured as polymer-dispersed liquid crystal (PD-LC) active panels.

8. A display device as recited in claim 1, wherein the multi-mode panel is further operable for activation of a first zone of the multi-mode panel for direct display on the display panel, and further operable for concurrent transparent display of at least a second zone of the multi-mode panel.

9. A display device as recited in claim 1, wherein the display controller is further configured to control the activation of the multi-mode panel for transparency based on at least one of all of the multi-mode panel, a section of the multi-mode panel, a pixel of the multi-mode panel, or a set of pixels of the multi-mode panel.

10. A transparent display, comprising:
a lighting system configured to direct light from a light source to illuminate a display panel;
a multi-mode panel operable as a transparent panel and further operable for activation to control a portion of the light from the light source; and
an active diffuser operable as an additional transparent panel and further operable for activation to diffuse the light that illuminates the display panel.

11. A transparent display as recited in claim 10, wherein the multi-mode panel and the active diffuser are configured to switch-off for transparency to permit an image being viewable through the transparent display.

12. A transparent display as recited in claim 11, wherein the light is ambient light that illuminates the display panel when the multi-mode panel and the active diffuser are switched-off for transparency.

13. A transparent display as recited in claim 10, wherein the multi-mode panel comprises an active shutter operable for activation to absorb the portion of the light from the light source.

14. A transparent display as recited in claim 10, wherein the multi-mode panel comprises an active reflector operable for activation to reflect the portion of the light from the light source back to the display panel.

15. A transparent display as recited in claim 10, wherein the multi-mode panel comprises a first zone operable for activation for direct display on the display panel, and further comprises at least a second zone for concurrent transparent display.

16. A transparent display as recited in claim 10, wherein the multi-mode panel is operable for activation of at least one of all of the multi-mode panel, a section of the multi-mode panel, a pixel of the multi-mode panel, or a set of pixels of the multi-mode panel.

17. A method, comprising:
directing light from a light source to illuminate a display panel of a display device;
controlling activation of a multi-mode panel that is operable as a transparent panel and further operable for activation to control a portion of the light from the light source; and
controlling activation of an active diffuser that is operable as an additional transparent panel and further operable for activation to diffuse the light that illuminates the display panel.

18. A method as recited in claim 17, further comprising absorbing the portion of the light from the light source with the multi-mode panel configured as an active shutter.

19. A method as recited in claim 17, further comprising reflecting the portion of the light from the light source with the multi-mode panel configured as an active reflector.

20. A method as recited in claim 17, further comprising:
switching-off the multi-mode panel and the active diffuser for transparency to permit an image being viewable through the display device; or
at least one of activating the multi-mode panel to said control the portion of the light from the light source, or activating the active diffuser to diffuse the light that illuminates the display panel.
